(19) United States
(12) Patent Application Publication
(10) Pub. No.: US 2024/0241355 A1
(43) Pub. Date: Jul. 18, 2024

(54) ZOOM LENS AND IMAGE PICKUP APPARATUS

(71) Applicant: CANON KABUSHIKI KAISHA, Tokyo (JP)

(72) Inventor: Shinichiro SAITO, Tochigi (JP)

(21) Appl. No.: 18/544,536

(22) Filed: Dec. 19, 2023

(30) Foreign Application Priority Data
Jan. 18, 2023 (JP) 2023-005613

(51) Int. Cl. G02B 15/14

(52) U.S. Cl. CPC G02B 15/1425

(57) ABSTRACT

A zoom lens includes, in order from an object side to an image side, a first lens unit having negative refractive power, a second lens unit having positive refractive power, and an aperture stop. A distance between adjacent lens units changes during zooming. The first lens unit includes at least three or four lens elements. Predetermined inequalities are satisfied.

### BACKGROUND

### Technical Field

One of the aspects of the embodiments relates to a zoom lens.

### Description of Related Art

A compact zoom lens with a wide angle of view is required as an imaging optical system for an image pickup apparatus such as a single-lens reflex camera, a video camera, a broadcasting camera, and a film-based camera. As such a zoom lens, Japanese Patent Laid-Open Nos. 2019-135552 and 2019-191307 disclose a zoom lens that includes, in order from the object side to the image side, a first lens unit having negative refractive power, a second lens unit having positive refractive power, and a subsequent lens unit.

A so-called negative lead type zoom lens that includes a first lens unit having negative refractive power has a retrofocus refractive power arrangement at the wide-angle end, and thus the wide angle of view scheme is relatively easy. In particular, ultra-wide-angle zoom lenses having an angle of view exceeding 90 degrees often use a negative lead type that can adopt a refractive power arrangement beneficial to aberration correction at the wide-angle end, in order to reduce the aberrational correction difficulty at the wide-angle end.

Japanese Patent Laid-Open No. 2022-126058 discloses a zoom lens that has a large aperture while shortening the overall optical length by placing lens units having negative refractive power closest to the object and the image plane.

In order to reduce the size of the negative lead type zoom lens and obtain a wide angle of view and high optical performance, it is important to properly arrange lens units in the zoom lens, and, in particular, to properly determine the configuration and power arrangement of the first lens unit.

### SUMMARY

A zoom lens according to one aspect of the embodiment includes, in order from an object side to an image side, a first lens unit having negative refractive power, a second lens unit having positive refractive power, and an aperture stop. A distance between adjacent lens units changes during zooming. The first lens unit includes at least four lens elements, and the following inequalities are satisfied:

$$0.05 \leq St / TDt \leq 0.45$$

$$0.3 \leq fG 1 / f 1 \leq 0.98$$

where f1 is a focal length of the first lens unit, fG1 is a focal length of a first negative lens closest to an object in the first lens unit, St is a distance on an optical axis from a surface closest to the object of the first lens unit to the aperture stop at a telephoto end, and TDt is a distance on the optical axis from a lens surface closest to the object of the zoom lens at the telephoto end to a lens surface closest to an image plane of the zoom lens at the telephoto end. Alternatively, the first lens unit consists of, in order from the object side to the image side, a first negative lens, a second negative lens, a third negative lens having a biconcave shape, and a positive lens, and the following inequality is satisfied:

$$0.30 \leq fG 1 / f 1 \leq 0. 86$$

where f1 is a focal length of the first lens unit, and fG1 is a focal length of the first negative lens. An image pickup apparatus having the above zoom lens also constitutes another aspect of the embodiment.

Further features of the disclosure will become apparent from the following description of embodiments with reference to the attached drawings.

### BRIEF DESCRIPTION OF THE DRAWINGS

FIG. 1 illustrates sectional views of a zoom lens according to Example 1 at a wide-angle end (WIDE), an intermediate zoom position (MIDDLE), and a telephoto end (TELE).

FIGS. 2A, 2B, and 2C are aberration diagrams of the zoom lens according to Example 1 at the wide-angle end, intermediate zoom position, and telephoto end.

FIG. 3 is a sectional view of a zoom lens according to Example 2 at a wide-angle end, intermediate zoom position, and telephoto end.

FIGS. 4A, 4B, and 4C are aberration diagrams of the zoom lens according to Example 2 at the wide-angle end, intermediate zoom position, and telephoto end.

FIG. 5 is a sectional view of a zoom lens according to Example 3 at a wide-angle end, intermediate zoom position, and telephoto end.

FIGS. 6A, 6B, and 6C are aberration diagrams of the zoom lens according to Example 3 at the wide-angle end, intermediate zoom position, and telephoto end.

FIG. 7 is a sectional view of a zoom lens according to Example 4 at a wide-angle end, intermediate zoom position, and telephoto end.

FIGS. 8A, 8B, and 8C are aberration diagrams of the zoom lens according to Example 4 at the wide-angle end, intermediate zoom position, and telephoto end.

FIG. 9 is a schematic diagram of an image pickup apparatus including the zoom lens according to any one of Examples 1 to 4.

### DESCRIPTION OF THE EMBODIMENTS

Referring now to the accompanying drawings, a description will be given of embodiments.

Zoom lenses according to Examples 1 to 4, which will be described below, have a plurality of lens units including, in order from the object side to the image side, a first lens unit having negative refractive power and a second lens unit having positive refractive power. Zoom lenses further include an aperture stop on the image side than of second lens unit. During zooming from a wide-angle end to a telephoto end, at least the first lens unit L1 moves, and a distance between the first lens unit L1 and the second lens unit L2 narrows.

In a zoom lens, a lens unit is a group of one or more lenses that move together during zooming between the wide-angle end and the telephoto end. That is, a distance between adjacent lens units changes during zooming. The lens unit may include an aperture stop. The wide-angle end and telephoto end are zoom states of a maximum angle of view (shortest focal length) and a minimum angle of view (maximum focal length), respectively, in a case where the lens unit that moves during zooming is located at both ends of a mechanically movable or controllable range on the optical axis.

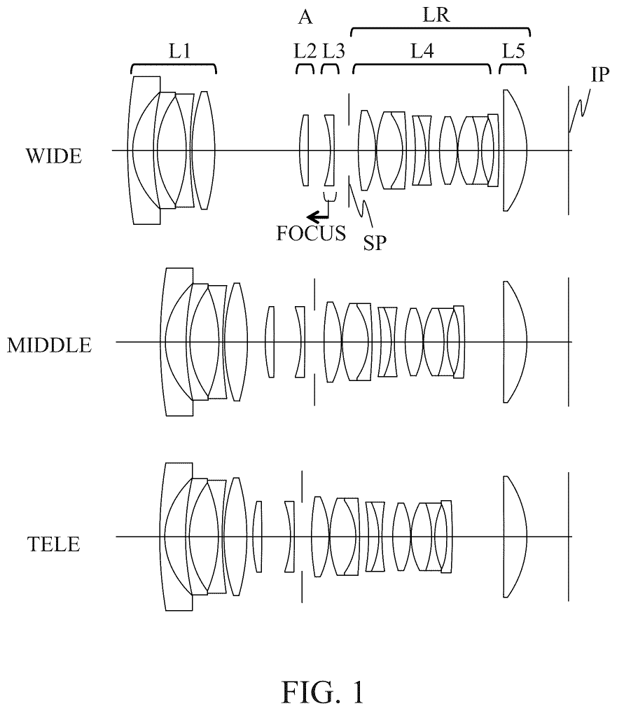

FIG. 1 illustrates sections of the zoom lens according to Example 1 at the wide-angle end, intermediate zoom position, and telephoto end. Numerical example 1 corresponding to Example 1 will be illustrated below. The zoom lens according to numerical example 1 is a zoom lens with a zoom ratio of about 1.8 and an aperture ratio of about 2.9.

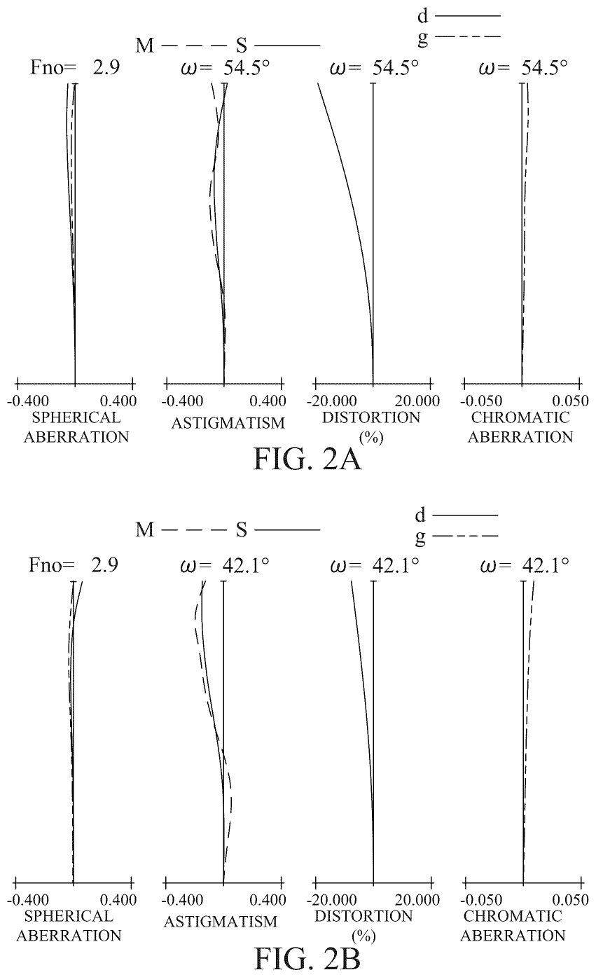

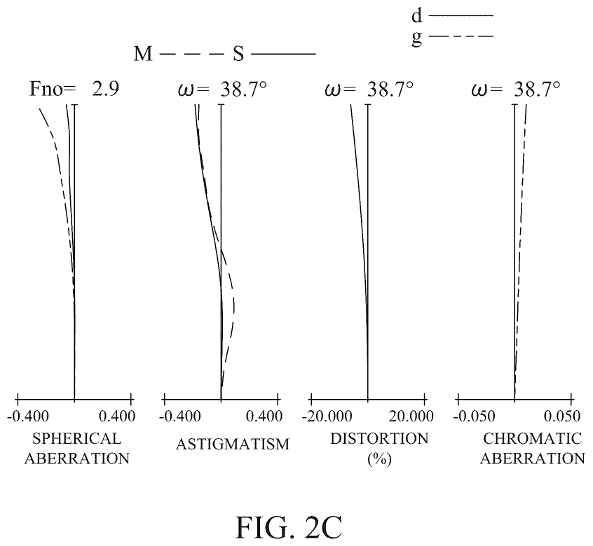

FIGS. 2A, 2B, and 2C illustrate longitudinal aberrations (spherical aberration, astigmatism, distortion, and chromatic aberration) at the wide-angle end, intermediate zoom position, and telephoto end of the zoom lens according to numerical example 1, respectively. In the spherical aberration diagram, Fno represents an F-number, a solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line S indicates a sagittal image plane, and a broken line M indicates a meridional image plane. The distortion is illustrated for the d-line. The chromatic aberration diagram illustrates a lateral chromatic aberration amount at the g-line. ω is a half angle of view (°).

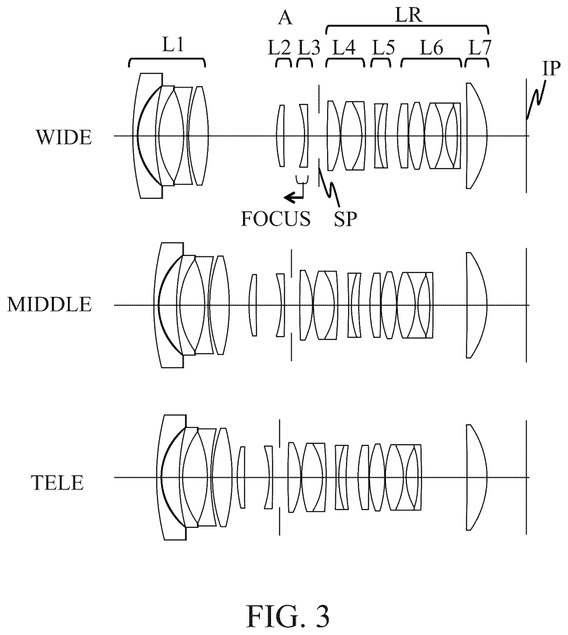

FIG. 3 illustrates sections of the zoom lens according to Example 2 at the wide-angle end, intermediate zoom position, and telephoto end. Numerical example 2 corresponding to Example 2 will be illustrated below. The zoom lens according to Numerical Example 2 is a zoom lens with a zoom ratio of about 1.7 and an aperture ratio of about 2.9.

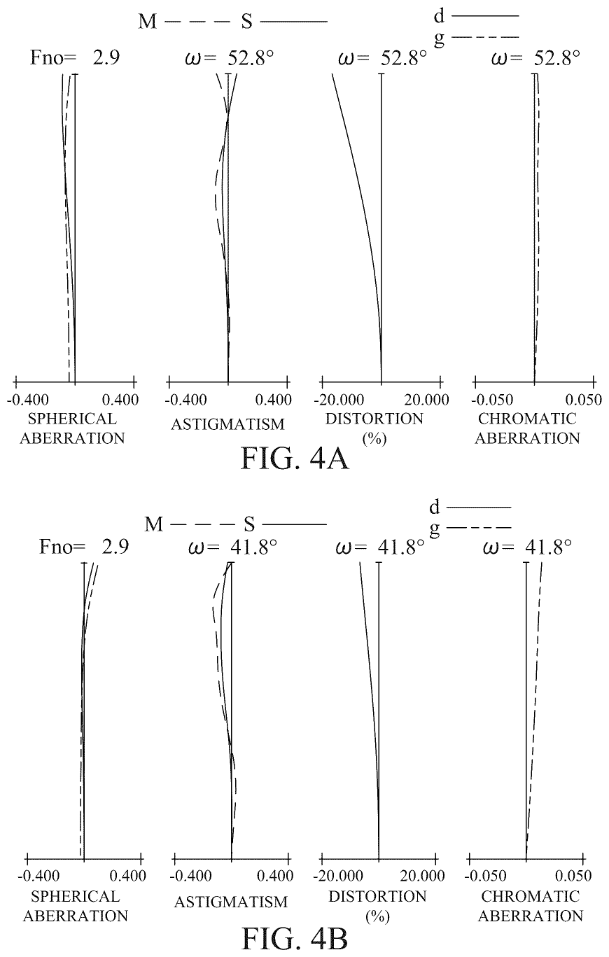

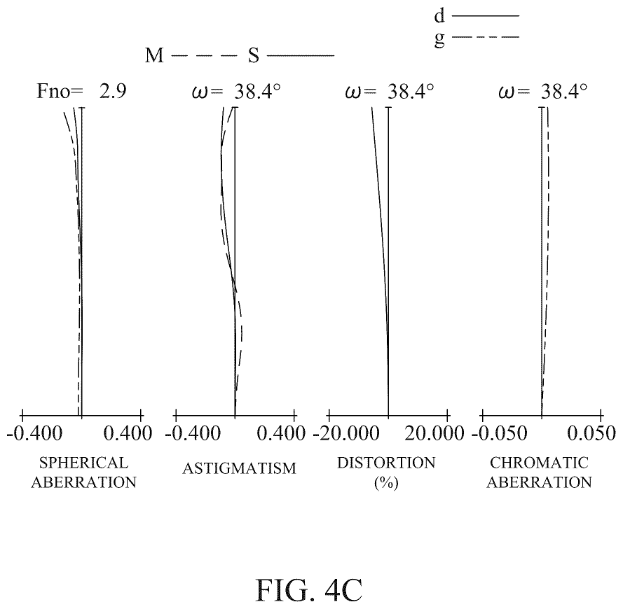

FIGS. 4A, 4B, and 4C illustrate the longitudinal aberration of the zoom lens of Numerical Example 2 at the wide-angle end, intermediate zoom position, and telephoto end, respectively.

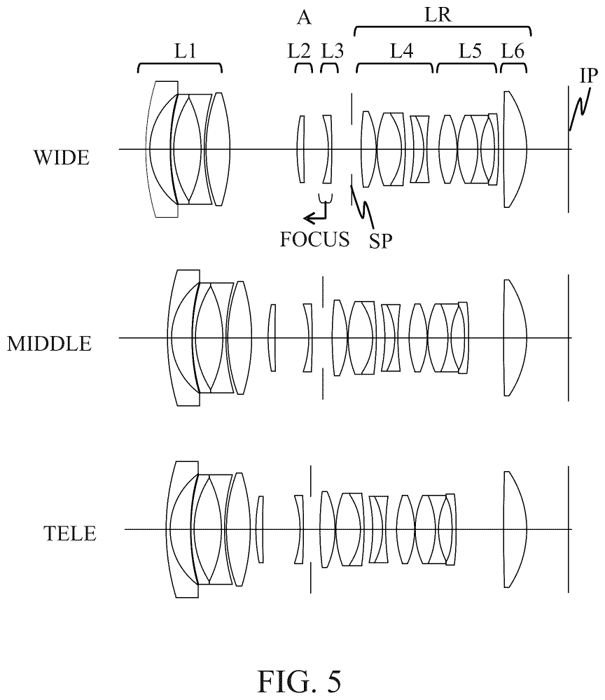

FIG. 5 illustrates sections of the zoom lens according to Example 3 at the wide-angle end, intermediate zoom position, and telephoto end. Numerical example 3 corresponding to Example 3 will be illustrated below. The zoom lens according to numerical example 3 is a zoom lens with a zoom ratio of about 1.7 and an aperture ratio of about 2.9.

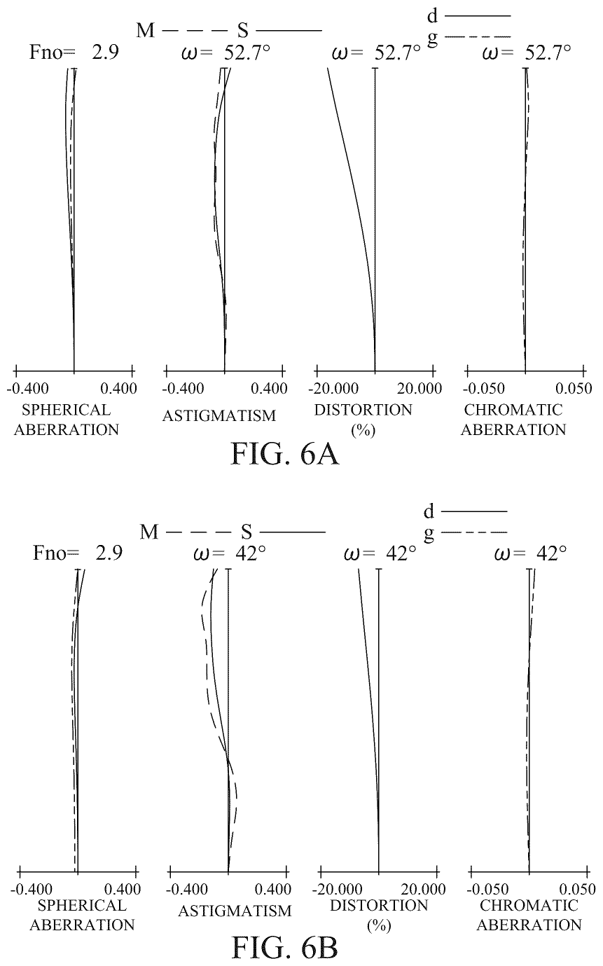

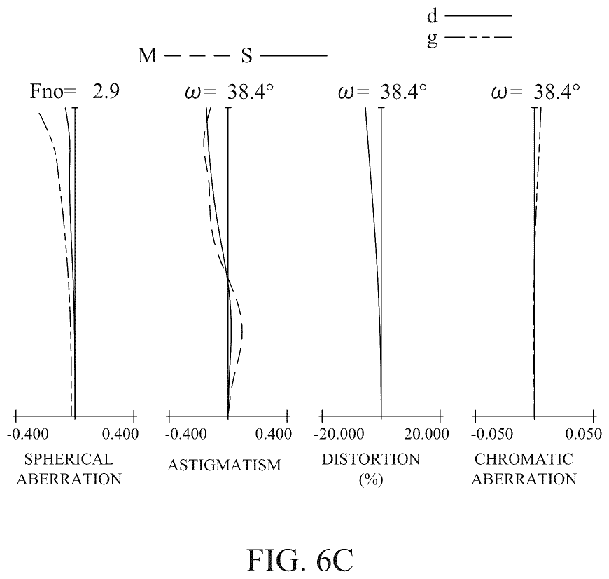

FIGS. 6A, 6B, and 6C illustrate the longitudinal aberration of the zoom lens according to numerical example 3 at the wide-angle end, intermediate zoom position, and telephoto end, respectively.

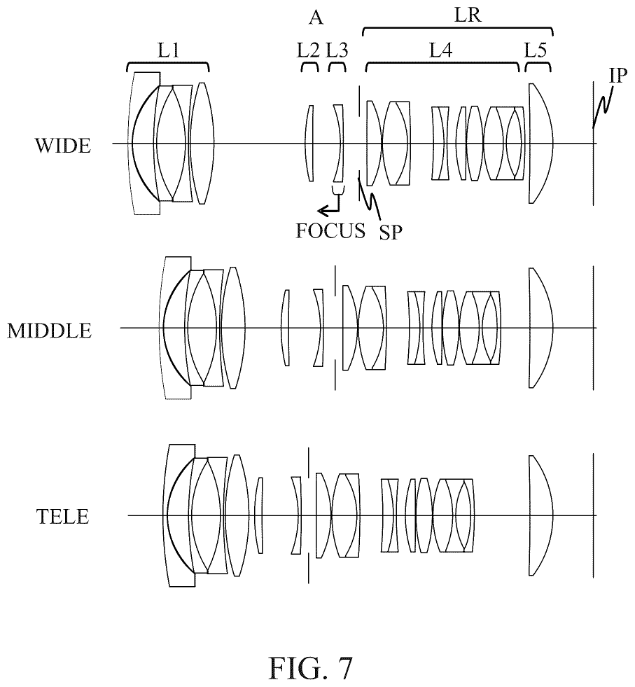

FIG. 7 illustrates sections of the zoom lens according to Example 4 at the wide-angle end, intermediate zoom position, and telephoto end. Numerical example 4 corresponding to Example 4 will be illustrated below. The zoom lens according to numerical example 4 is a zoom lens with a zoom ratio of about 1.8 and an aperture ratio of about 2.9.

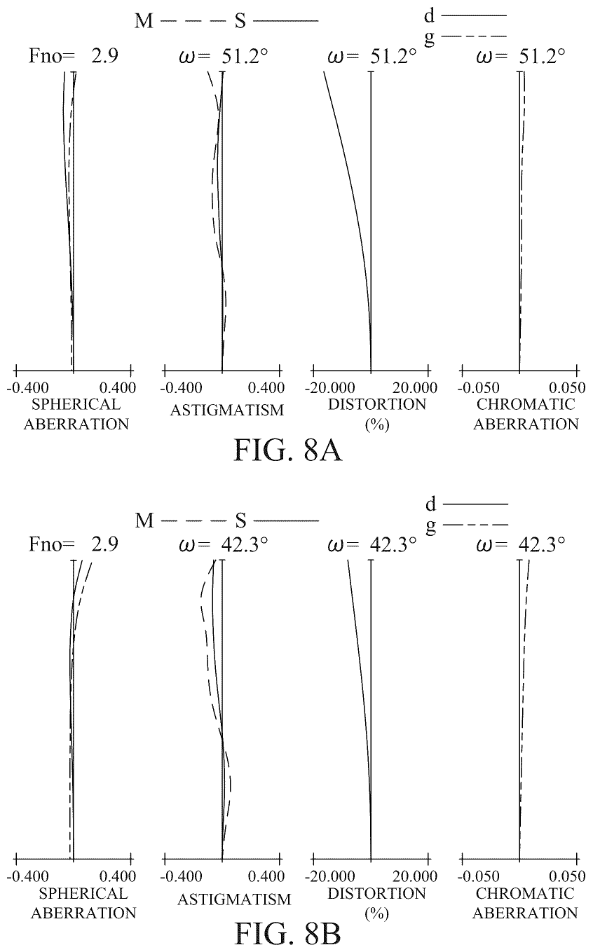

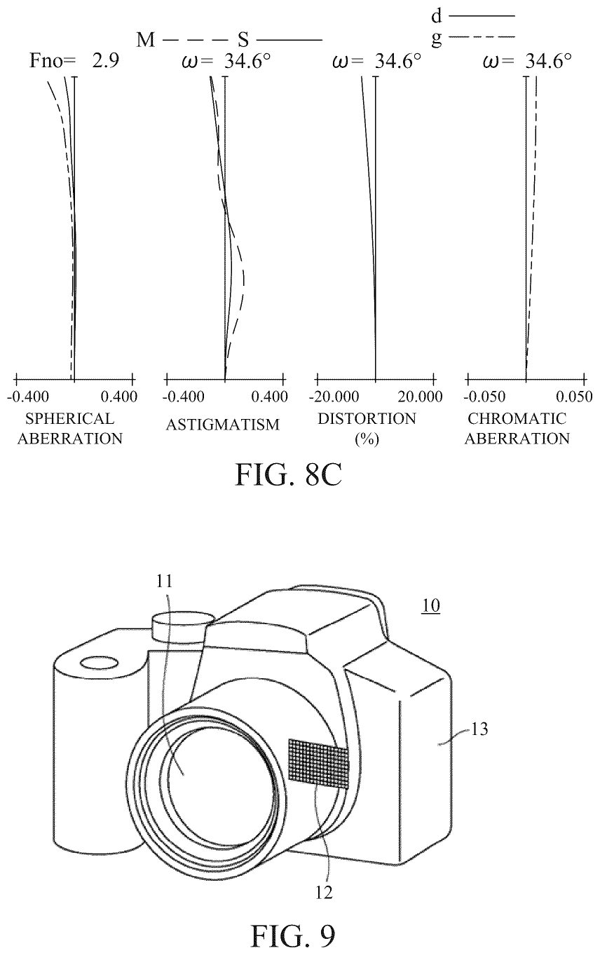

FIGS. 8A, 8B, and 8C illustrate the longitudinal aberration of the zoom lens according to numerical example 4 at the wide-angle end, intermediate zoom position, and telephoto end, respectively.

The zoom lens according to each example is used as an imaging optical system in an image pickup apparatus such as a video camera, a digital still camera, a film-based camera, and a TV camera. The zoom lens according to each example can also be used as a projection optical system for a projector. In each sectional view, a left side is an object side (front) and a right side is an image side (back). Where i is the order of the lens units counted from the object side, Li indicates an i-th lens unit.

SP represents an aperture stop that determines (limits) a light beam of a maximum open F-number (Fno). IP represents an image plane. An imaging surface of a solid-state image sensor (photoelectric conversion element) such as a CCD sensor or a CMOS sensor, and a film surface (photosensitive surface) of a film-based camera are arranged on the image plane IP.

In each sectional view, an arrow labeled “Focus” below the lens unit indicates a direction in which the lens unit moves during focusing from infinity to a close distance.

The zoom lens according to Example 1 illustrated in FIG. 1 includes five lens units that include a first lens unit L1 having negative refractive power, a second lens unit L2 having positive refractive power, a third lens unit L3 having negative refractive power, a fourth lens unit having positive refractive power, and a fifth lens unit L5 having positive refractive power.

The first lens unit L1 has four lens elements. One lens element includes a single lens or a cemented lens in which a negative lens and a positive lens are cemented. In the case of a composite optical element (hybrid aspherical surface or replica aspherical surface) such as a replica resin layer, the resin layer is included in a single lens element. More specifically, for example, in a case where a resin layer with a thickness of 0.5 mm or less on the optical axis is formed on the optical element, the element including the optical element and the resin layer is considered to be a single lens element. In specifying the material of the optical element, the resin layer is not considered.

In the zoom lens according to Example 1, during zooming from the wide-angle end to the telephoto end in an in-focus state at infinity, the first lens unit L1 to the third lens unit L3 move so such that a distance between the first lens unit L1 and the second lens unit L2 decreases and a distance between the second lens unit L2 and the third lens unit L3 increases. At this time, the fourth lens unit L4 monotonically moves toward the object side. The fifth lens unit L5 is stationary relative to the image plane.

The zoom lens according to Example 2 illustrated in FIG. 3 includes seven lens units that include a first lens unit L1 having negative refractive power, a second lens unit L2 having positive refractive power, a third lens unit L3 having negative refractive power, a fourth lens unit having positive refractive power L4, a fifth lens unit L5 having negative refractive power, a sixth lens unit L6 having positive refractive power, and a seventh lens unit L7 having positive refractive power. In this example, the first lens unit L1 has four lens elements.

In the zoom lens according to Example 2, during zooming from the wide-angle end to the telephoto end in the in-focus state at infinity, the first lens unit L1 to the third lens unit L3 move so that a distance between the first lens unit L1 and the second lens unit L2 decreases and a distance between the second lens unit L2 and the third lens unit L3 increases. At this time, the fourth lens unit L4 and the sixth lens unit L6 monotonically move toward the object side. The seventh lens unit L7 is stationary relative to the image plane.

The zoom lens according to Example 3 illustrated in FIG. 5 includes six lens units that include a first lens unit L1 having negative refractive power, a second lens unit L2 having positive refractive power, a third lens unit L3 having negative refractive power, a fourth lens unit having positive refractive power, a fifth lens unit L5 having positive refractive power, and a sixth lens unit L6 having positive refractive power. Even in this example, the first lens unit L1 has four lens elements.

In the zoom lens according to Example 3, during zooming from the wide-angle end to the telephoto end in the in-focus state at infinity, the first lens unit L1 to the third lens unit L3 move so that a distance between the first lens unit L1 and the second lens unit L2 decreases and a distance between the second lens unit L2 and the third lens unit L3 increases. At this time, the fourth lens unit L4 and the fifth lens unit L5 monotonically move toward the object side. The sixth lens unit L6 is stationary relative to the image plane.

The zoom lens according to Example 4 illustrated in FIG. 7 includes five lens units that include a first lens unit L1 having negative refractive power, a second lens unit L2 having positive refractive power, a third lens unit L3 having negative refractive power, a fourth lens unit L4 having positive refractive power, and a fifth lens unit L5 having positive refractive power. Even in this example, the first lens unit L1 has four lens elements.

In the zoom lens according to Example 4, during zooming from the wide-angle end to the telephoto end in the in-focus state at infinity, the first lens unit L1 to the third lens unit L3 move so that a distance between the first lens unit L1 and the second lens unit L2 decreases and a distance between the second lens unit L2 and the third lens unit L3 increases. At this time, the fourth lens unit L4 monotonically moves toward the object side. The fifth lens unit L5 is stationary relative to the image plane.

In the zoom lens according to each example, in a case where the first lens unit L1 has four lens elements, f1 is a focal length of the first lens unit L1, and fG1 is a focal length of a negative lens closest to the object of the first lens unit L1 (zoom lens). St is a distance on the optical axis from a surface (frontmost surface) closest to the object of the zoom lens to the aperture stop SP at the telephoto end. TDt is an overall optical length (lens overall length) of the zoom lens at the telephoto end. Then, the following inequalities (1) and (2) are satisfied:

$$0.05 \leq St / TDt \leq 0.45 \qquad ( 1 )$$

$$0.3 \leq fG 1 / f 1 \leq 0.98 \qquad ( 2 )$$

The zoom lens according to each example includes, in order from the object side, a first lens unit L1 having negative refractive power and a second lens unit L2 having positive refractive power in order to ensure a wide angle of view and a predetermined zoom ratio and to satisfactorily correct aberrations. It further includes an aperture stop SP on the image side of the second lens unit L2. Selecting the negative lead type in this way can place the rear principal point on the image side, and can provide a wide-angle zoom lens that achieves both a wide angle of view and a small diameter of the first lens unit.

The first lens unit L1 has at least four lens elements including a first lens having negative refractive power and disposed closest to the object. Thereby, the diameter of the first lens unit L1 can be reduced while lateral chromatic aberration that may be generated in the wide angle of view scheme can be suppressed. As described above, the cemented lens is considered to be a single lens element, and the replica resin layer in the composite optical element is not counted as a single lens element.

In the zoom lens according to each example, during zooming from the wide-angle end to the telephoto end, the first lens unit L1 moves toward the image side from the zoom position at the wide-angle end to the intermediate zoom position. Using a retrofocus type power arrangement in the wide-angle range can satisfactorily correct the curvature of field and lateral chromatic aberration in the wide-angle range. During zooming from the wide-angle end to the telephoto end, the second lens unit L2 having positive refractive power moves toward the object side, and the distance between the first lens unit L1 and the second lens unit L2 decreases. Various aberrations can be satisfactorily corrected by changing distances among all lens units during zooming.

As the entire zoom lens becomes smaller, various aberrations, especially chromatic aberrations such as longitudinal chromatic aberration and lateral chromatic aberration, often occur, and optical performance tends to lower. In particular, in retrofocus type zoom lenses that attempt to reduce the diameter of the first lens unit L1 and the overall lens length, chromatic aberration increases as the focal length becomes shorter.

The first lens unit L1 has the role of imaging a pupil of the off-axis principal ray at the center of the aperture stop SP, and since a refraction amount of the off-axis principal ray is large especially on the wide-angle side, various off-axis aberrations, especially astigmatism and distortion are likely to occur. For miniaturization, a wide angle is attempted by giving large refractive power to a negative lens closest to the object, and distortion and lateral chromatic aberration caused by this are corrected by image processing (electronic distortion correction).

The first lens unit L1 has at least four lens elements to satisfactorily correct lateral chromatic aberration and curvature of field and to secure a wide angle of view and a predetermined zoom ratio. The retrofocus type power arrangement in the first lens unit L1 can provide a wide-angle zoom lens in which the first lens unit L1 is small.

Inequality (1) defines a distance St from the frontmost surface to the aperture stop SP at the telephoto end using the overall lens length TDt at the telephoto end, and indicates a condition to reduce the overall lens length and suppress the occurrence of various aberrations, especially lateral chromatic aberration. In a case where St becomes large (long) so that St/TDt becomes higher than the upper limit of inequality (1), it is beneficial to aberrational corrections, but it causes an increase in the aperture diameter and the diameter of the subsequent lens unit. As a result, it becomes difficult to reduce the weight, especially the focus lens unit. In a case where Tdw becomes large (long) so that St/TDt becomes lower than the lower limit of inequality (1), it is easier to suppress the aperture diameter, but it causes an increase in the overall optical length.

Inequality (2) defines the focal length fG1 of the negative lens closest to the object in the first lens unit L1 using the focal length of the first lens unit L1. This is to reduce the diameter of the first lens unit L1 and the overall length of the zoom lens, which are problems in the wide angle of view scheme. In a case where fG1/f1 becomes higher than the upper limit of inequality (2), it is beneficial to lateral chromatic aberration correction, but this causes an increase in the diameter of the first lens unit L1. In a case where fG1/f1 becomes lower than the lower limit of inequality (2), it becomes difficult to correct curvature of field and distortion. As a result, the number of lenses increases, the overall lens length increases.

Placing the second lens unit L2 having positive refractive power closest to the object on the image side of the first lens unit L1 can easily secure eccentric position accuracy, which becomes a problem in increasing the aperture diameter or shortening the overall length, and can suppress eccentric coma.

As described above, an ultra-wide-angle zoom lens having an angle of view at the wide-angle end exceeding 90 degrees and excellent optical performance over the entire zoom range can be obtained by having a proper lens unit configuration and satisfying inequalities (1) and (2) at the same time.

On the other hand, in a case where the first lens unit L1 has at least three lens elements, the following inequalities (1T) and (2T) may be satisfied:

$$0.050 \leq St / TDt \leq 0.405 \qquad ( 1 T )$$

$$0.3 \leq fG 1 / f 1 \leq 0.86 \qquad ( 2 T )$$

In order to secure a wide angle of view and a predetermined zoom ratio, and to satisfactorily correct lateral chromatic aberration and curvature of field, the first lens unit L1 includes at least three lens elements. In this case, at least one lens element may include a cemented lens. In a case where the first lens unit L1 has three components, the retrofocus type power arrangement in the first lens unit L1 can provide a wide-angle zoom lens that includes the first lens unit L1 with a small diameter.

As described above, an ultra-wide-angle zoom lens having an angle of view at the wide-angle end exceeding 90 degrees and excellent optical performance over the entire zoom range can be obtained by having a proper lens unit configuration and satisfying inequalities (1T) and (2T) at the same time.

Inequalities (1) and (2) may be replaced with inequalities (1a) and (2a) as follows:

$$0.10 \leq St / TDt \leq 0.43 \qquad ( 1 a )$$

$$0.52 \leq fG 1 / f 1 \leq 0.9 \qquad ( 2 a )$$

Satisfying inequality (1a) can easily suppress an increase in the aperture diameter and coma fluctuations against the image height. Satisfying inequality (2a) can reduce the diameter of the first lens unit L1 while properly correcting various aberrations.

Inequalities (1) and (2) may be replaced with inequalities (1b) and (2b) as follows:

$$0.30 \leq St / TDt \leq 0.41 \qquad ( 1 b )$$

$$0.74 \leq fG 1 / f 1 \leq 0.85 \qquad ( 2 b )$$

A description will now be given of conditions that may be satisfied by the zoom lens according to each example.

Now assume that fw and ft are focal lengths at the wide-angle end and telephoto end of the zoom lens, respectively, and fLRw is a combined focal length at the wide-angle end of the rear group LR, which includes at least one lens unit on the image side of the aperture stop SP9 (in the case of a single lens unit, it is the focal length of that lens unit). In addition, assume that fR is a focal length of the lens unit closest to the image plane of the zoom lens. nd1m is a refractive index for the d-line of a lens made of a material with the maximum refractive index for the d-line among at least one lens included in the first lens unit L1, νd1m an Abbe number based on the d-line, and θgF1m is a partial dispersion ratio between the d-line and the F-line. ndpa and vdpa are the average refractive index and Abbe number of at least one positive lens included in the first lens unit L1, respectively.

The first lens unit L1 includes, in order from the object side to the image side, a negative lens (first negative lens) G1 and a negative lens (second negative lens) G2, and fG1N and fG2N are focal lengths of the negative lenses G1 and G2, respectively. skm is a minimum value of the back focus in the entire zoom range. The back focus is a distance on the optical axis from the lens surface closest to the image plane (final surface) of the zoom lens to the image plane (paraxial image plane from a paraxial object point). In a case where an optical element, which is not a lens unit but has an extremely weak refractive power, is placed between the final surface and the image plane, an air converted value of this optical element is used as the back focus.

The Abbe number νd and the partial dispersion ratio θgF are expressed as follows:

$$v d = ( Nd - 1 ) / ( NF - NC )$$

$$θ gF = ( Ng - NF ) / ( NF - NC )$$

where Nd, NF, NC, and Ng are refractive indices based on the d-line (587.6 nm), the F-line (486.1 nm), the C-line (656.3 nm), and the g-line (435.8 nm) in the Fraunhofer line, respectively.

Now assume that V is a third-order aberration coefficient of distortion at the wide-angle end. fX and SFX are a focal length and shape factor of object-side lens element X adjacent to and located on the object side of the aperture stop SP. The shape factor in a case where the lens element is a cemented lens is defined as a shape of the object-side surface and image-side surface of the cemented lens, and the cemented surface is not considered. In a case where any of the surfaces has an aspherical shape, it is expressed by its base R (radius of a quadratic curved surface serving as a reference). The shape factor SFX is defined by the following equation:

$$SFX = ( RX 2 + RX 1 ) / ( RX 2 - RX 1 )$$

where RX1 is a radius of curvature of the object-side surface of the object-side lens element X, and RX2 is a radius of curvature of the image-side surface of the object-side lens element X.

The zoom lens according to each example may satisfy at least one of the following inequalities (3) to (12):

$$1.9 \leq nd 1 m \leq 2.4 \qquad ( 3 )$$

$$23 \leq vd 1 m \leq 40 \qquad ( 4 )$$

$$0.57 \leq θ gF 1 m \leq 0.64 \qquad ( 5 )$$

$$0.35 \leq \vert fG 1 / fG 2 \vert \leq 0.64 \qquad ( 6 )$$

$$1.8 \leq \vert f 1 \vert / skm \leq 4.2 \qquad ( 7 )$$

$$0.98 \leq SFX \leq 3. \qquad ( 8 )$$

$$1. \leq fX / f 1 \leq 2.4 \qquad ( 9 )$$

$$0.4 \leq \vert f 1 \vert / fLRw \leq 0.7 \qquad ( 10 )$$

$$0.15 \leq fw / fR \leq 0. 40 \qquad ( 11 )$$

$$0.2 \leq V \leq 1. \qquad ( 12 )$$

Inequalities (3) and (4) define the refractive index nd1m and Abbe number νd1m of a lens made of a material with the largest refractive index among the lenses in the first lens unit L1. Due to the characteristic of glass, as the refractive index increases, the Abbe number tends to decrease and the partial dispersion ratio θgF tends to increase. In a case where a lens is made of a material with a high refractive index, the curvature is likely to be small (the radius of curvature is likely to be large) and various aberrations can be easily corrected.

A high refractive index material that is used for the positive lens of the first lens unit L1 having negative refractive power as a whole in a retrofocus zoom lens is beneficial to the primary achromatic effect of the first lens unit L1 and the reduced size of the zoom lens. However, it becomes difficult to correct the secondary spectrum of lateral chromatic aberration. In addition, in the case where the high refractive index material is used for the positive lens of the first lens unit L1 having negative refractive power as a whole, first-order achromatization of lateral chromatic aberration tends to be insufficient. Thus, it is important to properly set the refractive index and Abbe number of the lens made of the material with the maximum refractive index.

In a case where nd1m becomes higher than the upper limit of inequality (3), it is beneficial to image plane correction, but it becomes difficult to correct lateral chromatic aberration. In a case where nd1m becomes lower than the lower limit of inequality (3), it is necessary to weaken the refractive power of the negative lens to correct the curvature of field, and consequently causes an increase in the diameter of the first lens unit L1 and an increase in back focus.

In a case where νd1m becomes higher than the upper limit of inequality (4), it is beneficial to lateral chromatic aberration correction, but it becomes difficult to secure the desired refractive power as a glass material. In a case where νd1m becomes lower than the lower limit of inequality (4), first-order achromatization of lateral chromatic aberration and longitudinal chromatic aberration becomes difficult.

Inequality (5) defines the partial dispersion ratio of the lens made of the material with the highest refractive index among the lenses in the first lens unit L1, and indicates a condition for balancing various aberrations such as lateral chromatic aberration and longitudinal chromatic aberration. In a case where θgF1m becomes higher than the upper limit of inequality (5), it is beneficial to longitudinal chromatic aberration correction, but the partial dispersion ratio becomes too large, causing a change (curvature) in lateral chromatic aberration for each image height. In a case where θgF1m becomes lower than the lower limit of inequality (5), the share of chromatic aberration by the lens on the image side of the aperture stop SP increases, and it becomes necessary to place a lens with a large partial dispersion ratio at a high ray height position, which causes the diameter and mass to increase.

Inequality (6) defines the refractive power sharing between the negative lens G1N and the negative lens G2N. In a case where the negative lenses G1N and G2N are composite optical elements such as a replica resin layer, they are treated as a single lens element including the resin layer as described above. In order to make the entire zoom lens system compact and widen the angle of view, each example includes two negative lenses arranged in order from the object side, and their refractive power sharing is defined by inequality (6).

In a case where |fG1/fG2| becomes higher than the upper limit of inequality (6), the refractive power of the negative lens G1N closest to the object becomes weak, and the diameter of the first lens unit L1 becomes larger. In a case where |fG1/fG2| becomes lower than the lower limit of inequality (6), the refractive power of the negative lens G1N closest to the object becomes stronger, which is beneficial to size reduction of the first lens unit L1, but it becomes difficult to correct curvature of field and astigmatism.

Inequality (7) defines the focal length f1 of the first lens unit L1 using the minimum value skm of the back focus in the entire zoom range, and indicates a condition to shorten the overall optical length at the wide-angle end and secure high optical performance. The overall optical length is the sum of the length on the optical axis from the frontmost surface to the final surface of the zoom lens (overall lens length) added to the back focus BF as an air converted value.

The negative lead type zoom lens is designed to have an approximately entirely retrofocus type refractive power arrangement at the wide-angle end to achieve a wide angle. Thus, in order to shorten the overall lens length at the wide-angle end, it is necessary to properly set the refractive power of the first lens unit L1. Satisfying inequality (7) can achieve both miniaturization and high performance of the zoom lens.

In a case where |f1|/skm becomes higher than the upper limit of inequality (7), the refractive power of the first lens unit L1 decreases and the overall lens length increases in securing the desired angle of view at the wide-angle end. In a case where |f1|/skm becomes lower than the lower limit of inequality (7), the refractive power of the first lens unit L1 increases, it becomes difficult to correct lateral chromatic aberration and curvature of field at the telephoto side, and correcting spherical aberration and coma at the telephoto side becomes insufficient.

Inequality (8) defines the shape factor of the object-side lens element X adjacent to and on the object side of the aperture stop SP, and is a condition for properly correcting spherical aberration and coma. In a case where SFX becomes higher than the upper limit of inequality (8), the meniscus shape of the lens element X becomes strong and it becomes difficult to manufacture the lens. In a case where SFX becomes lower than the lower limit of inequality (8), the incident angle of an off-axis ray on the lens surface increases, and a performance change increases due to manufacturing errors during lens assembly.

Inequality (9) defines the refractive power of the lens element X, and indicates a condition for achieving a wide angle while satisfactorily suppressing spherical aberration and coma. In a case where fX/f1 becomes higher than the upper limit of inequality (9), the refractive power of the lens element X becomes weaker, and it becomes difficult to shorten the distance St and to achieve both a wide angle of view and miniaturization. In a case where fX/f1 becomes lower than the lower limit of inequality (9), the refractive power of lens element X becomes stronger, which is beneficial to the wide angle of view scheme, but it becomes difficult to correct spherical aberration and coma in the telephoto range.

Inequality (10) defines the focal length f1 of the first lens unit L1 having negative refractive power using the combined focal length fRw at the wide-angle end of the rear group LR on the image side of the aperture stop SP. In a case where |f1|/fLRw becomes higher than the upper limit of inequality (10), the negative refractive power of the first lens unit L1 becomes stronger, a divergence effect of a marginal ray becomes larger, and it becomes difficult to correct spherical aberration and coma in the rear group LR. In a case where |f1|/fLRw becomes lower than the lower limit of inequality (10), the positive refractive power of the rear group LR becomes stronger, a convergence effect becomes larger, and it becomes difficult to achieve both suppression of the secondary spectra of lateral chromatic aberration and longitudinal chromatic aberration.

Inequality (11) defines the focal length fw of the zoom lens at the wide-angle end using the focal length fR of the lens unit closest to the image plane among the lens units whose distance does not change during zooming. Satisfying this inequality (11) can reduce the overall lens length while securing the back focus. In a case where the focal length at the wide-angle end becomes longer so that fw/fR becomes higher than the upper limit of inequality (11), deterioration of off-axis aberration can be alleviated, but it becomes difficult to correct spherical aberration at the telephoto end in the large aperture diameter scheme. In a case where the refractive power of the lens unit closest to the image plane is reduced so that fw/fR becomes lower than the lower limit of inequality (11), it becomes difficult to secure the back focus.

Inequality (12) defines the third-order aberration coefficient of distortion, and indicates a condition for properly correcting curvature of field and astigmatism, and further suppressing resolution deterioration due to stretching in electronic distortion correction. In a case where V becomes higher than the upper limit of inequality (12), distortion increases, which is beneficial to the reduced size of the zoom lens, but the resolution deterioration due to stretching increases. In a case where V becomes lower than the lower limit of inequality (12), it becomes difficult to satisfactorily correct curvature of field and lateral chromatic aberration.

In a case where an optical image formed by a zoom lens is received by an image sensor, the following inequality (13) may be satisfied:

$$45 ° \leq ω w \leq 60 ° \qquad ( 13 )$$

where ωw is a half angle of view at the wide-angle end obtained by ray tracing.

In a case where ow becomes higher than the upper limit of inequality (13), image compression at each angle of view becomes high, and it becomes difficult to obtain sufficient resolution. In a case where ow becomes lower than the lower limit of inequality (13), the angle of view necessary for a wide-angle zoom lens cannot be obtained.

In the zoom lens according to each example, the first lens unit L1 includes five or fewer lenses. This configuration can reduce the number of lenses in the first lens unit L1 having a large diameter, and the size and weight of the first lens unit L1. In order to miniaturize the first lens unit L1 and to satisfactorily correct an off-axis aberration such as curvature of field and astigmatism in a wide-angle range, three negative lenses may be consecutively arranged in the first lens unit L1 in order from the object side. Thereby, the retrofocus type power arrangement in the first lens unit L1 can be made and curvature of field and coma can be satisfactorily corrected in a wide-angle range.

The first lens unit L1 may include one single lens (fixed focal length lens) having positive refractive power, and the single lens may have a refractive index of 1.7 or more. Thereby, it becomes easy to satisfactorily correct lateral chromatic aberration over the entire zoom range and to reduce the diameter of the first lens unit L1.

In the zoom lens according to each example, the first lens unit L1 may include three spherical lenses. Three spherical lenses in the first lens unit L1 can suppress surface shape errors (so-called errors of astigmatism and irregularity components) that are likely to occur with aspheric lenses, and satisfactorily correct astigmatism.

In the zoom lens according to each example, the second lens unit L2 may include one positive lens. Thereby, the diameter of the light beam emitted from the first lens unit L1 can be suppressed, and the size of the zoom lens can be easily reduced. In a case where the focus lens unit is disposed adjacent to and on the image side of the second lens unit L2, the on-axis ray can be made almost afocal, and fluctuations of spherical aberration and coma due to focusing can be easily suppressed. The Abbe number of one positive lens in the second lens unit L2 based on the d-line may be 40 or more and 60 or less. This configuration can suppress aberrational fluctuations during focusing on a close object, and variations in coma for each wavelength during focusing.

In the zoom lens according to each example, the third lens unit L3 may include one negative lens. This facilitates quick focusing in a case where the third lens unit L3 is used as a focus lens unit. Using the lens unit adjacent to the aperture stop SP as the focus lens unit can suppress an increase in the mass of the focus lens unit, which tends to become a problem in a case where the aperture diameter is increased. The following inequality (14) may be satisfied:

$$0.2 \leq \vert f 3 / f 2 \vert \leq 1. \qquad ( 14 )$$

where f2 and f3 are focal lengths of the second lens unit L2 and the third lens unit L3, respectively,

Inequality (14) defines the focal length of the third lens unit L3 using the focal length of the fourth lens unit L4. In a case where |f3/f2 becomes higher than the upper limit of inequality (14), the refractive power of the third lens unit L3 becomes weaker, and it is necessary to secure a wide movement space for the third lens unit L3 to perform focusing within the zoom lens. As a result, the overall lens length increases. In a case where |f3/f2 becomes lower than the lower limit of inequality (14), the convergence of the light beam exiting from the second lens unit L2 becomes weaker, and fluctuations in spherical aberration and longitudinal chromatic aberration due to focusing occur.

The Abbe number of one negative lens in the third lens unit L3 based on the d-line may be 45 or more and 60 or less. Thereby, longitudinal chromatic aberration can be suppressed during focusing on a close object.

In the zoom lens according to each example, the rear group LR on the image side of the aperture stop SP may include a plurality of positive lenses having an Abbe number of 75 or more based on the d-line. In order to satisfactorily correct lateral chromatic aberration caused by the wide angle of view scheme and longitudinal chromatic aberration caused by the large aperture diameter scheme, at least two positive lenses having an Abbe number of 75 or more may be disposed. Three positive lenses having an Abbe number of 75 or more may be disposed.

The lens unit closest to the image plane in the zoom lens according to each example is made fixed (not moved) relative to the image plane during zooming, thereby dust adhesion can be reduced, which could be a problem when the lens unit is removed from the image pickup apparatus like an interchangeable lens, and durability can be easily secured.

In the zoom lens according to each example, the lens closest to the image plane in the lens unit closest to the image plane may be a lens having a convex shape on the image side. This configuration can relatively easily secure the back focus, and suppress the collection of unnecessary light (ghost) caused by the image sensor.

In the zoom lens according to each example, at least one of the lens surfaces on the image side of the aperture stop SP may have an aspherical shape. This configuration can effectively correct curvature of field at the wide-angle end and reduce the size of the zoom lens.

In the zoom lens according to each example, a protective glass for protecting the lens may be disposed on the object side of the first lens unit L1. A protective glass or a low-pass filter may be disposed between the lens placed closest to the image plane and the image plane. An optical element with extremely weak refractive power, such as a protective glass and low-pass filter, which is disposed closest to the object or closest to the image plane, is not treated as a lens constituting the zoom lens. The “optical element with extremely weak refractive power” is, for example, an optical element whose absolute value of a focal length is five times or more as long as the focal length of the zoom lens.

In the zoom lens according to each example, the aperture stop SP may be adjacent to and on the image side of the third lens unit L3. This configuration can secure a predetermined angle of view at the wide-angle end, and easily suppress an increase in the diameter of the first lens unit L1 in the high magnification variation ratio scheme.

In the zoom lens according to each example, the lens adjacent to and on the image side of the aperture stop SP may include a lens element (single lens or cemented lens) having a strongly convex shape on the object side. A lens surface having a strongly convex shape facing the aperture stop SP can easily suppress spherical aberration associated with the larger aperture diameter scheme and easily correct various off-axis aberrations in a wide-angle range. A cemented lens having this strongly convex element can easily correct spherical aberration, coma, and curvature of field.

In the zoom lens according to each example, the whole or part of any one of the lens units may be moved in a direction orthogonal to the optical axis as an image stabilizing unit for image stabilization. Movement in the direction orthogonal to the optical axis includes movement in a direction including a component in the direction orthogonal to the optical axis (for example, rotation around a point on the optical axis). In the zoom lenses according to Examples 1 to 4, image stabilization may performed by moving the cemented lens consisting of the tenth lens and the eleventh lens. There is no limit to the number or shape of lenses in the image stabilizing unit. Moreover, the image stabilizing unit may have negative refractive power.

In the zoom lens according to each example, focusing can be performed by moving all or part of any one of lens units in the optical axis direction as a focus unit.

The zoom lens according to each example may not include a diffractive optical element. Although the diffractive optical element is beneficial to chromatic aberration correction, diffraction flare occurs in the diffractive optical element.

Inequalities (3) to (12) may be replaced with inequalities (3a) to (12a) as follows:

$$1.905 \leq nd 1 m \leq 2.200 \qquad ( 3 a )$$

$$25 \leq vd 1 m \leq 38 \qquad ( 4 a )$$

$$0.575 \leq θ gF 1 m \leq 0.625 \qquad ( 5 a )$$

$$0.39 \leq \vert fG 1 / fG 2 \vert \leq 0.60 \qquad ( 6 a )$$

$$2.2 \leq \vert f 1 \vert / skm \leq 3.5 \qquad ( 7 a )$$

$$1. \leq SFX \leq 2. \qquad ( 8 a )$$

$$1.1 \leq fX / f 1 \leq 2. \qquad ( 9 a )$$

$$0.45 \leq \vert f 1 \vert / fLRw \leq 0.65 \qquad ( 10 a )$$

$$0.18 \leq fw / fR \leq 0. 30 \qquad ( 11 a )$$

$$0.22 \leq V \leq 0.50 \qquad ( 12 a )$$

Inequalities (3) to (12) may be replaced with inequalities (3b) to (12b) as follows:

$$1.91 \leq nd 1 m \leq 2.1 \qquad ( 3 b )$$

$$28 \leq vd 1 m \leq 36 \qquad ( 4 b )$$

$$0.58 \leq θ gF 1 m \leq 0.61 \qquad ( 5 b )$$

$$0.42 \leq \vert fG 1 / fG 2 \vert \leq 0.56 \qquad ( 6 b )$$

$$2.5 \leq \vert f 1 \vert / skm \leq 3.1 \qquad ( 7 b )$$

$$1.1 \leq SFX \leq 1.4 \qquad ( 8 b )$$

$$1.2 \leq fX / f 1 \leq 1.6 \qquad ( 9 b )$$

$$0.5 \leq \vert f 1 \vert / fLRw \leq 0.6 \qquad ( 10 b )$$

$$0.2 \leq fw / fR \leq 0. 26 \qquad ( 11 b )$$

$$0.25 \leq V \leq 0.32 \qquad ( 12 b )$$

In the zoom lenses according to Examples 1 to 4, each lens unit is moved during zooming to reduce the size of the entire system. Each example can provide a zoom lens with high imaging performance by properly setting the magnification variation burden due to the configuration and power arrangement of each lens unit.

Numerical examples 1 to 4 will be illustrated below. In each numerical example, the surface number i indicates the order of the surfaces when counted from the object side. r represents a radius of curvature of an i-th surface from the object side (mm), d represents a lens thickness or air distance (mm) between i-th and (i+1)-th surfaces, and nd is a refractive index for the d-line of an optical material between i-th and (i+1)-th surfaces. νd and θgF are the Abbe number and partial dispersion ratio of the optical material between the i-th surface and the (i+1)-th surface. BF represents back focus (mm). The back focus and the overall lens length are as described above. The half angle of view is based on ray tracing.

An asterisk “*” attached to the surface number means that the surface has an aspherical shape. The aspherical shape is defined as follows:

$$X = \frac{\frac{{H}^{2}}{R}}{1 + \sqrt{1 - ( 1 + k ) {( \frac{H}{R} )}^{2}}} + A 4 {H}^{4} + A 6 {H}^{6} + A 8 {H}^{8} + A 10 {H}^{10} + A 12 {H}^{12}$$

where X is a displacement amount from a surface vertex in the optical axis direction, H is a height from the optical axis in the direction orthogonal to the optical axis, a light traveling direction is set positive, R is a paraxial radius of curvature, K is a conic constant, and A4, A6, A8, A10, and A12 are aspheric coefficients. “e-x” in the conic constant and aspherical coefficient means ×10^{-x}. Table 1 summarizes the numerical values relating to inequalities (1) to (12) in each numerical example.

NUMERICAL EXAMPLE 1
UNIT: mm
SURFACE DATA

| Surface | | | | | |
|---|---|---|---|---|---|
| Data | r | d | nd | νd | θgF |
| 1 | 144.3036 | 1.600 | 1.88202 | 37.22 | 0.5770 |
| 2* | 22.1371 | 6.609 | | | |
| 3 | 83.0958 | 1.200 | 1.80420 | 46.50 | 0.5572 |
| 4 | 28.6986 | 9.218 | | | |
| 5 | −44.7549 | 1.200 | 1.49700 | 81.61 | 0.5386 |
| 6 | 125.9165 | 0.600 | | | |
| 7 | 59.3716 | 7.271 | 1.91082 | 35.25 | 0.5824 |
| 8 | −70.2249 | (Variable) | | | |
| 9 | 50.1715 | 2.830 | 1.65160 | 58.54 | 0.5390 |
| 10 | −660.8048 | (Variable) | | | |
| 11 | −34.0489 | 1.200 | 1.77250 | 49.63 | 0.5508 |
| 12 | −526.4616 | (Variable) | | | |
| 13 | ∞ | 3.000 | | | |
| (SP) | | | | | |
| 14 | 74.6203 | 5.539 | 1.55032 | 75.50 | 0.5405 |
| 15 | −30.9554 | 0.300 | | | |
| 16 | 33.7448 | 8.252 | 1.49700 | 81.61 | 0.5386 |
| 17 | −20.0789 | 1.200 | 1.80440 | 39.59 | 0.5729 |
| 18 | −130.5977 | 2.863 | | | |
| 19 | −66.6857 | 3.246 | 1.84666 | 23.79 | 0.6191 |
| 20 | −26.7237 | 1.000 | 1.60562 | 43.70 | 0.5721 |
| 21 | 72.9080 | 3.410 | | | |
| 22 | 33.2273 | 5.671 | 1.43700 | 95.10 | 0.5326 |
| 23 | −27.5238 | 0.200 | | | |
| 24 | 22.7871 | 6.500 | 1.43700 | 95.10 | 0.5326 |
| 25 | −31.6567 | 1.000 | 1.83481 | 42.72 | 0.5650 |
| 26 | 25.0720 | 3.826 | | | |
| 27* | −64.2569 | 1.700 | 1.58313 | 59.46 | 0.5418 |
| 28* | −800.0000 | (Variable) | | | |
| 29 | −1991.3434 | 7.318 | 1.48749 | 70.44 | 0.5303 |
| 30 | −33.1143 | 13.270 | | | |
| Image | ∞ | | | | |
| Plane | | | | | |

ASPHERIC DATA
2nd Surface
K = 0.00000e+00 A 4 = −7.11444e−06 A 6 = 2.28099e−09 A 8 = −8.75851e−11
A10 = 2.46405e−13 A12 = −4.26701e−16
27th Surface
K = 0.00000e+00 A 4 = −7.98050e−05 A 6 = 4.31831e−07 A 8 = −1.02601e−08
A10 = 9.74514e−11 A12 = −3.31880e−13
28th Surface
K = 0.00000e+00 A 4 = −3.06766e−05 A 6 = 2.19257e−07 A 8 = −3.28288e−09
A10 = 3.23801e−11 A12 = −9.88714e−14

VARIOUS DATA
Zoom Ratio 1.754

| | WIDE | MIDDLE | TELE |
|---|---|---|---|
| Focal Length | 15.488 | 24.114 | 27.160 |
| Fno | 2.900 | 2.900 | 2.900 |
| Half Angle of | 54.532 | 42.075 | 38.744 |
| View (°) | | | |
| Image Height | 17.550 | 20.100 | 20.460 |
| Overall Lens | 140.161 | 129.781 | 129.964 |
| Length | | | |
| BF | 13.270 | 13.270 | 13.270 |
| d 8 | 26.926 | 5.641 | 1.872 |
| d10 | 6.971 | 8.548 | 9.157 |
| d12 | 4.664 | 3.088 | 2.479 |
| d28 | 1.575 | 12.481 | 16.432 |

LENS UNIT DATA

| Lens | Starting | Focal |
|---|---|---|
| Unit | Surface | Length |
| 1 | 1 | −36.383 |
| 2 | 9 | 71.676 |
| 3 | 11 | −47.174 |
| 4 | 13 | 27.146 |
| 5 | 29 | 68.992 |

NUMERICAL EXAMPLE 2
UNIT: mm
SURFACE DATA

| Surface | | | | | |
|---|---|---|---|---|---|
| Data | r | d | nd | νd | θgF |
| 1 | 91.0024 | 1.600 | 1.95375 | 32.32 | 0.5898 |
| 2 | 22.9141 | 0.250 | 1.51640 | 52.16 | 0.5566 |
| 3* | 20.6753 | 6.317 | | | |
| 4 | 74.3507 | 1.200 | 1.71300 | 53.94 | 0.5439 |
| 5 | 28.0389 | 8.910 | | | |
| 6 | −40.8896 | 1.200 | 1.49700 | 81.61 | 0.5386 |
| 7 | 79.2087 | 0.600 | | | |
| 8 | 54.0309 | 7.068 | 1.91082 | 35.25 | 0.5824 |
| 9 | −70.3602 | (Variable) | | | |
| 10 | 47.2746 | 2.602 | 1.65160 | 58.40 | 0.5399 |
| 11 | 471.6859 | (Variable) | | | |
| 12 | −35.2786 | 1.200 | 1.69350 | 53.34 | 0.5462 |
| 13 | −403.9895 | (Variable) | | | |
| 14 | ∞ | 3.000 | | | |
| (SP) | | | | | |
| 15 | 289.8874 | 4.608 | 1.55032 | 75.50 | 0.5405 |
| 16 | −30.3005 | 0.300 | | | |
| 17 | 41.4830 | 7.511 | 1.49700 | 81.61 | 0.5386 |
| 18 | −22.5302 | 1.300 | 1.80610 | 40.73 | 0.5670 |
| 19 | −130.7862 | (Variable) | | | |
| 20 | −292.1911 | 1.000 | 1.70154 | 41.15 | 0.5765 |
| 21 | 35.6517 | 2.663 | 1.84666 | 23.79 | 0.6191 |
| 22 | 86.6772 | (Variable) | | | |
| 23 | 46.5997 | 3.838 | 1.43700 | 95.10 | 0.5326 |
| 24 | −460.5014 | 0.200 | | | |
| 25 | 33.9936 | 5.541 | 1.49700 | 81.61 | 0.5386 |
| 26 | −42.0956 | 0.200 | | | |
| 27 | 35.8410 | 6.500 | 1.55032 | 75.50 | 0.5405 |
| 28 | −25.2113 | 1.000 | 1.83481 | 42.72 | 0.5650 |
| 29 | 21.4777 | 4.257 | | | |
| 30* | −78.3877 | 1.200 | 1.58313 | 59.46 | 0.5418 |
| 31* | −1000.0000 | (Variable) | | | |
| 32 | −794.2155 | 7.195 | 1.48749 | 70.44 | 0.5303 |
| 33 | −33.1520 | 14.138 | | | |
| Image | ∞ | | | | |
| Plane | | | | | |

ASPHERIC DATA
3rd Surface
K = 0.00000e+00 A 4 = −1.01362e−05 A 6 = 1.09536e−08 A 8 = −2.12261e−10
A10 = 6.98940e−13 A12 = −1.19477e−15
30th Surface
K = 0.00000e+00 A 4 = −5.32124e−05 A 6 = 4.76879e−07 A 8 = −1.02863e−08
A10 = 8.98188e−11 A12 = −2.75136e−13
31st Surface
K = 0.00000e+00 A 4 = −1.85160e−05 A 6 = 2.91270e−07 A 8 = −5.21828e−09
A10 = 4.45444e−11 A12 = −1.26266e−13

VARIOUS DATA
Zoom Ratio 1.656

| | WIDE | MIDDLE | TELE |
|---|---|---|---|
| Focal Length | 16.482 | 24.144 | 27.299 |
| Fno | 2.900 | 2.900 | 2.900 |
| Half Angle of | 52.826 | 41.811 | 38.443 |
| View(°) | | | |
| Image Height | 18.100 | 20.150 | 20.460 |
| Overall Lens | 141.472 | 133.916 | 132.922 |
| Length | | | |
| BF | 14.138 | 14.138 | 14.138 |
| d 9 | 24.526 | 7.062 | 1.845 |
| d11 | 7.469 | 9.000 | 8.929 |
| d13 | 3.970 | 2.439 | 2.510 |
| d19 | 3.524 | 3.838 | 3.524 |
| d22 | 4.309 | 3.995 | 4.309 |
| d31 | 2.276 | 12.185 | 16.407 |

LENS UNIT DATA

| Lens | Starting | Focal |
|---|---|---|
| Unit | Surface | Length |
| 1 | 1 | −35.685 |
| 2 | 10 | 80.438 |
| 3 | 12 | −55.812 |
| 4 | 14 | 39.298 |
| 5 | 20 | −123.718 |
| 6 | 23 | 86.827 |
| 7 | 32 | 70.749 |

NUMERICAL EXAMPLE 3
UNIT: mm
SURFACE DATA

| Surface | | | | | |
|---|---|---|---|---|---|
| Data | r | d | nd | νd | θgF |
| 1 | 76.5467 | 1.300 | 2.00100 | 29.13 | 0.5997 |
| 2 | 22.4418 | 6.615 | | | |
| 3* | 88.7043 | 0.100 | 1.51640 | 52.20 | 0.5565 |
| 4 | 64.8907 | 1.000 | 1.91082 | 35.25 | 0.5824 |
| 5 | 31.0140 | 8.823 | | | |
| 6 | −37.6193 | 1.000 | 1.49700 | 81.61 | 0.5386 |
| 7 | 63.5472 | 0.600 | | | |
| 8 | 53.2335 | 7.706 | 1.95375 | 32.32 | 0.5898 |
| 9 | −62.3908 | (Variable) | | | |
| 10 | 55.1718 | 2.205 | 1.71700 | 47.92 | 0.5605 |
| 11 | 408.0859 | (Variable) | | | |
| 12 | −33.7809 | 1.100 | 1.65844 | 50.88 | 0.5560 |
| 13 | −223.7955 | (Variable) | | | |
| 14 | ∞ | 3.000 | | | |
| (SP) | | | | | |
| 15 | 103.2989 | 4.869 | 1.55032 | 75.50 | 0.5405 |
| 16 | −30.8935 | 0.300 | | | |
| 17 | 32.8265 | 7.880 | 1.48071 | 85.29 | 0.5362 |
| 18 | −20.0628 | 1.200 | 1.80100 | 34.97 | 0.5864 |
| 19 | −83.1668 | 2.752 | | | |
| 20 | −51.2246 | 3.193 | 1.84666 | 23.87 | 0.6205 |
| 21 | −23.3554 | 1.000 | 1.61340 | 44.27 | 0.5633 |
| 22 | 77.7350 | (Variable) | | | |
| 23 | 32.2685 | 5.817 | 1.43700 | 95.10 | 0.5326 |
| 24 | −27.6423 | 0.200 | | | |
| 25 | 26.6231 | 6.500 | 1.55032 | 75.50 | 0.5405 |
| 26 | −27.1134 | 1.000 | 1.83481 | 42.74 | 0.5648 |
| 27 | 22.2325 | 4.370 | | | |
| 28* | −63.9148 | 1.300 | 1.58313 | 59.46 | 0.5418 |
| 29* | −800.0000 | (Variable) | | | |
| 30 | 575.7567 | 7.464 | 1.48749 | 70.44 | 0.5303 |
| 31 | −33.6058 | 13.451 | | | |
| Image | ∞ | | | | |
| Plane | | | | | |

ASPHERIC DATA
3rd Surface
K = 0.00000e+00 A 4 = 6.17177e−06 A 6 = −1.29518e−08 A 8 = 7.88098e−11
A10 = −2.12643e−13 A12 = 2.51829e−16
28th Surface
K = 0.00000e+00 A 4 = −1.03256e−04 A 6 = 6.08804e−07 A 8 = −1.15508e−08
A10 = 1.01885e−10 A12 = −3.26591e−13
29th Surface
K = 0.00000e+00 A 4 = −5.85318e−05 A 6 = 4.06348e−07 A 8 = −4.66597e−09
A10 = 4.05409e−11 A12 = −1.14325e−13

VARIOUS DATA
Zoom Ratio 1.651

| | WIDE | MIDDLE | TELE |
|---|---|---|---|
| Focal Length | 16.475 | 24.092 | 27.202 |
| Fno | 2.900 | 2.900 | 2.900 |
| Half Angle of | 52.731 | 41.964 | 38.429 |
| View (°) | | | |
| Image Height | 18.100 | 20.150 | 20.420 |
| Overall Lens | 136.256 | 129.250 | 129.690 |
| Length | | | |
| BF | 13.451 | 13.451 | 13.451 |
| d 9 | 21.615 | 5.293 | 1.793 |
| d11 | 7.910 | 10.917 | 12.042 |
| d13 | 6.437 | 3.429 | 2.304 |
| d22 | 3.924 | 3.614 | 3.511 |
| d29 | 1.627 | 11.254 | 15.297 |

LENS UNIT DATA

| Lens | Starting | Focal |
|---|---|---|
| Unit | Surface | Length |
| 1 | 1 | −38.998 |
| 2 | 10 | 88.746 |
| 3 | 12 | −60.564 |
| 4 | 14 | 44.682 |
| 5 | 23 | 129.769 |
| 6 | 30 | 65.397 |

NUMERICAL EXAMPLE 4
UNIT: mm
SURFACE DATA

| Surface | | | | | |
|---|---|---|---|---|---|
| Data | r | d | nd | νd | θgF |
| 1 | 127.4188 | 1.400 | 1.95375 | 32.32 | 0.5898 |
| 2 | 24.9178 | 0.100 | 1.51640 | 52.16 | 0.5566 |
| 3* | 22.4657 | 6.955 | | | |
| 4 | 98.9687 | 1.000 | 1.71300 | 53.94 | 0.5439 |
| 5 | 33.6571 | 9.494 | | | |
| 6 | −41.0481 | 1.000 | 1.49700 | 81.61 | 0.5386 |
| 7 | 144.1644 | 0.600 | | | |
| 8 | 67.9850 | 7.804 | 1.91082 | 35.25 | 0.5824 |
| 9 | −64.9779 | (Variable) | | | |
| 10 | 54.3568 | 2.484 | 1.65160 | 58.54 | 0.5390 |
| 11 | 609.5662 | (Variable) | | | |
| 12 | −35.7502 | 1.000 | 1.64850 | 53.02 | 0.5547 |
| 13 | −287.7205 | (Variable) | | | |
| 14 | ∞ | 2.500 | | | |
| (SP) | | | | | |
| 15 | 1537.8893 | 4.844 | 1.55032 | 75.50 | 0.5405 |
| 16 | −32.4433 | 0.300 | | | |
| 17 | 38.6332 | 8.251 | 1.52841 | 76.46 | 0.5396 |
| 18 | −25.4116 | 1.000 | 1.79360 | 37.09 | 0.5828 |
| 19 | −200.3780 | 7.553 | | | |
| 20 | −132.9533 | 3.460 | 1.85896 | 22.73 | 0.6284 |
| 21 | −40.8207 | 1.000 | 1.74400 | 44.78 | 0.5655 |
| 22 | 116.4327 | 2.961 | | | |
| 23 | 39.6295 | 3.294 | 1.43700 | 95.10 | 0.5326 |
| 24 | −1056.6036 | 0.200 | | | |
| 25 | 45.5758 | 5.408 | 1.49700 | 81.61 | 0.5386 |
| 26 | −42.9428 | 0.200 | | | |
| 27 | 32.0183 | 6.500 | 1.55397 | 71.76 | 0.5389 |
| 28 | −30.3223 | 1.000 | 1.88100 | 40.14 | 0.5706 |
| 29 | 23.3060 | 4.890 | | | |
| 30* | −58.6534 | 1.200 | 1.58313 | 59.46 | 0.5418 |
| 31* | −700.0000 | (Variable) | | | |
| 32 | −583.9845 | 7.559 | 1.48749 | 70.44 | 0.5303 |
| 33 | −33.2011 | 13.330 | | | |
| Image | ∞ | | | | |
| Plane | | | | | |

ASPHERIC DATA
3rd Surface
K = 0.00000e+00 A 4 = −7.45027e−06 A 6 = 4.25581e−09 A 8 = −9.63349e−11
A10 = 2.71199e−13 A12 = −4.22553e−16
30th Surface
K = 0.00000e+00 A 4 = −1.05495e−04 A 6 = 8.55788e−07 A 8 = −1.06693e−08
A10 = 7.47737e−11 A12 = −2.06882e−13
31st Surface
K = 0.00000e+00 A 4 = −6.84221e−05 A 6 = 6.50483e−07 A 8 = −5.61205e−09
A10 = 3.36657e−11 A12 = −7.90314e−14

VARIOUS DATA
Zoom Ratio 1.789

| | WIDE | MIDDLE | TELE |
|---|---|---|---|
| Focal Length | 17.423 | 24.044 | 31.170 |
| Fno | 2.900 | 2.900 | 2.900 |
| Half Angle of | 51.201 | 42.348 | 34.556 |
| View (°) | | | |
| Image Height | 18.100 | 20.150 | 20.430 |
| Overall Lens | 153.392 | 143.135 | 141.859 |
| Length | | | |
| BF | 13.330 | 13.330 | 13.330 |
| d 9 | 30.057 | 11.866 | 1.842 |
| d11 | 9.116 | 10.473 | 11.922 |
| d13 | 5.232 | 3.875 | 2.427 |
| d31 | 1.701 | 9.635 | 18.383 |

LENS UNIT DATA

| Lens | Starting | Focal |
|---|---|---|
| Unit | Surface | Length |
| 1 | 1 | −40.840 |
| 2 | 10 | 91.426 |
| 3 | 12 | −63.048 |
| 4 | 14 | 30.594 |
| 5 | 32 | 71.888 |

TABLE 1
Numerical Example

| | 1 | 2 | 3 | 4 |
|---|---|---|---|---|
| fw | 15.488 | 16.482 | 16.475 | 17.423 |
| ft | 27.160 | 27.299 | 27.202 | 31.170 |
| f1 | −36.383 | −35.685 | −38.998 | −40.840 |
| f2 | 71.676 | 80.438 | 88.746 | 91.426 |
| f3 | −47.174 | −55.812 | −60.564 | −63.048 |
| f4 | 27.146 | 39.298 | 44.682 | 30.594 |
| f5 | 68.992 | −123.718 | 129.769 | 71.888 |
| f6 | | 86.827 | 65.397 | |
| f7 | | 70.749 | | |
| TDw | 126.890 | 127.334 | 122.805 | 140.062 |
| TDt | 116.693 | 118.784 | 116.240 | 128.529 |
| skw | 13.270 | 14.138 | 13.451 | 13.330 |
| skt | 13.270 | 14.138 | 13.451 | 13.330 |
| LDw | 140.161 | 141.472 | 136.256 | 153.392 |
| LDt | 129.964 | 132.922 | 129.690 | 141.859 |
| Sw | 70.290 | 66.912 | 66.409 | 71.009 |
| St | 45.237 | 44.231 | 46.588 | 45.600 |
| β2w | −2.347 | −5.317 | −8.515 | −4.320 |
| β3w | −0.256 | −0.126 | −0.078 | −0.153 |
| β4w | −0.876 | −1.198 | −1.709 | −0.789 |
| β5w | 0.809 | 2.459 | 0.470 | 0.819 |
| β6w | | 0.292 | 0.790 | |
| β7w | | 0.803 | | |
| β2t | −13.051 | 10.652 | 9.441 | 12.967 |
| β3t | −0.050 | 0.066 | 0.074 | 0.054 |
| β4t | −1.423 | −1.906 | −3.487 | −1.335 |
| β5t | 0.809 | 5.499 | 0.364 | 0.819 |
| β6t | | 0.129 | 0.790 | |
| β7t | | 0.803 | | |
| fG1 | −29.829 | −30.085 | −32.104 | −30.441 |
| fG2 | −55.054 | −63.823 | −57.882 | −71.990 |
| fLRw | 30.4398 | 32.0821 | 31.9094 | 28.3060 |
| fLRt | 40.1303 | 41.2838 | 41.1915 | 28.1412 |
| fR | 68.9923 | 70.7487 | 65.3971 | 71.8883 |
| V | 0.2663 | 0.2697 | 0.3148 | 0.2865 |
| RX1 | −34.0489 | −35.2786 | −33.7809 | −35.7502 |
| RX2 | −526.4616 | −403.9895 | −223.7955 | −287.7205 |
| fX | −47.1740 | −55.8122 | −60.5644 | −63.0478 |
| (1)St/TDt | 0.388 | 0.372 | 0.401 | 0.355 |
| (2)fG1/f1 | 0.8199 | 0.8431 | 0.8232 | 0.7454 |
| (3)nd1m | 1.91082 | 1.95375 | 2.00100 | 1.95375 |
| (4)vd1m | 35.250 | 32.318 | 29.134 | 32.318 |
| (5)θgFUv | 0.5824 | 0.5898 | 0.5997 | 0.5898 |
| (6)\|fG1/fG2\| | 0.542 | 0.471 | 0.555 | 0.423 |
| (7)\|f1\|/skm | 2.742 | 2.524 | 2.899 | 3.064 |
| (8)SFX | 1.138 | 1.191 | 1.356 | 1.284 |
| (9)fX/f1 | 1.297 | 1.564 | 1.553 | 1.544 |
| (10)\|f1\|/fLRw | 0.527 | 0.504 | 0.596 | 0.568 |
| (11)fw/fR | 0.224 | 0.233 | 0.252 | 0.242 |
| (12)V | 0.266 | 0.270 | 0.315 | 0.286 |

### Image Pickup Apparatus

FIG. 9 illustrates a digital still camera (image pickup apparatus) using the zoom lens according to any one of Examples 1 to 4 as an imaging optical system. Reference numeral 10 denotes a camera body, and reference numeral 11 denotes an imaging optical system. Reference numeral 12 denotes a solid-state image sensor, such as a CCD sensor or a CMOS sensor, which is built into the camera body 10 and receives an optical image formed by the imaging optical system 11 and photoelectrically converts (images) it. The camera body 10 may be a single-lens reflex camera with a quick turn mirror, or a mirrorless camera without a quick turn mirror.

The zoom lens according to each example as an imaging optical system can provide an wholly compact image pickup apparatus that can acquire high-quality captured images.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide a zoom lens that is small and has a wide angle of view and good optical performance over the entire zoom range.

This application claims the benefit of Japanese Patent Application No. 2023-005613, filed on Jan. 18, 2023, which is hereby incorporated by reference herein in its entirety.

What is claimed is:

1. A zoom lens comprising, in order from an object side to an image side, a first lens unit having negative refractive power, a second lens unit having positive refractive power, and an aperture stop,
wherein a distance between adjacent lens units changes during zooming,
wherein the first lens unit includes at least four lens elements, and
wherein the following inequalities are satisfied:
$$0.05 \leq St / TDt \leq 0.45$$
$$0.3 \leq fG 1 / f 1 \leq 0.98$$
where f1 is a focal length of the first lens unit, fG1 is a focal length of a first negative lens closest to an object in the first lens unit, St is a distance on an optical axis from a surface closest to the object of the first lens unit to the aperture stop at a telephoto end, and TDt is a distance on the optical axis from a lens surface closest to the object of the zoom lens at the telephoto end to a lens surface closest to an image plane of the zoom lens at the telephoto end.

2. A zoom lens comprising, in order from an object side to an image side, a first lens unit having negative refractive power, a second lens unit having positive refractive power, and an aperture stop,
wherein a distance between adjacent lens units changes during zooming,
wherein the first lens unit consists of, in order from the object side to the image side, a first negative lens, a second negative lens, a third negative lens having a biconcave shape, and a positive lens, and
wherein the following inequality is satisfied:
$$0.3 \leq fG 1 / f 1 \leq 0.86$$
where f1 is a focal length of the first lens unit, and fG1 is a focal length of the first negative lens.

3. The zoom lens according to claim 1, wherein the following inequalities are satisfied:
$$1.9 \leq nd 1 m \leq 2.4$$
$$23 \leq vd 1 m \leq 40$$
where nd1m is a refractive index for d-line of a lens made of a material having a largest refractive index for the d-line among at least one lens included in the first lens unit, and νd1m is an Abbe number based on the d-line of the material.

4. The zoom lens according to claim 1, wherein the following inequality is satisfied:
$$0.57 \leq θ gF 1 m \leq 0.64$$
where θgF1m is a partial dispersion ratio between d-line and F-line of a lens made of a material having a largest refractive index for the d-line among at least one lens included in the first lens unit.

5. The zoom lens according to claim 1, wherein the first lens unit includes, in order from the object side to the image side, the first negative lens and a second negative lens that are successively arranged, and
wherein the following inequality is satisfied:
$$0.35 \leq \vert fG 1 / fG 2 \vert \leq 0.64$$
where fG1N and fG2N are focal lengths of the first negative lens and the second negative lens, respectively.

6. The zoom lens according to claim 1, wherein the following inequality is satisfied:
$$1.8 \leq \vert f 1 \vert / skm \leq 4.2$$
where skm is a minimum value of a back focus in an entire zoom range of the zoom lens.

7. The zoom lens according to claim 1, wherein the following inequality is satisfied:
$$0.98 \leq SFX \leq 3.$$
where SFX is a shape factor of a lens element adjacent to and on the object side of the aperture stop.

8. The zoom lens according to claim 1, wherein the following inequality is satisfied:
$$1. \leq fX / f 1 \leq 2.4$$
where fX is a focal length of a lens element adjacent to and located on the object side of the aperture stop.

9. The zoom lens according to claim 1, wherein the following inequality is satisfied:
$$0.4 \leq \vert f 1 \vert / fLRw \leq 0.7$$
where fLRw is a combined focal length at a wide-angle end of at least one lens unit disposed closer to the image plane than the aperture stop.

10. The zoom lens according to claim 1, wherein the following inequality is satisfied:
$$0.15 \leq fw / fR \leq 0.4$$
where fw is a focal length of the zoom lens at a wide-angle end, and fR is a focal length of a lens unit closest to the image plane of the zoom lens.

11. The zoom lens according to claim 1, wherein the following inequality is satisfied:
$$0.2 \leq V \leq 1.$$
where V is a third-order aberration coefficient of distortion at a wide-angle end in the zoom lens.

12. The zoom lens according to claim 2, wherein the following inequality is satisfied:
$$0.05 \leq St / TDt \leq 0.405$$
where St is a distance on an optical axis from a surface closest to the object of the first lens unit to the aperture stop at a telephoto end, and TDt is a distance on the optical axis from a lens surface closest to the object of the zoom lens at the telephoto end to a lens surface closest to an image plane of the zoom lens at the telephoto end.

13. An image pickup apparatus comprising:
a zoom lens; and
an image sensor configured to receive an optical image formed by the zoom lens,
wherein the zoom lens comprising, in order from an object side to an image side, a first lens unit having negative refractive power, a second lens unit having positive refractive power, and an aperture stop,
wherein a distance between adjacent lens units changes during zooming,
wherein the first lens unit includes at least four lens elements, and
wherein the following inequalities are satisfied:
$$0.05 \leq St / TDt \leq 0.45$$
$$0.3 \leq fG 1 / f 1 \leq 0.98$$
where f1 is a focal length of the first lens unit, fG1 is a focal length of a first negative lens closest to an object in the first lens unit, St is a distance on an optical axis from a surface closest to the object of the first lens unit to the aperture stop at a telephoto end, and TDt is a distance on the optical axis from a lens surface closest to the object of the zoom lens at the telephoto end to a lens surface closest to an image plane of the zoom lens at the telephoto end.

14. An image pickup apparatus comprising:
a zoom lens; and
an image sensor configured to receive an optical image formed by the zoom lens,
wherein the zoom lens comprising, in order from an object side to an image side, a first lens unit having negative refractive power, a second lens unit having positive refractive power, and an aperture stop,
wherein a distance between adjacent lens units changes during zooming,
wherein the first lens unit consists of, in order from the object side to the image side, a first negative lens, a second negative lens, a third negative lens having a biconcave shape, and a positive lens, and
wherein the following inequality is satisfied:
$$0.3 \leq fG 1 / f 1 \leq 0.86$$
where f1 is a focal length of the first lens unit, and fG1 is a focal length of the first negative lens.
